(19) United States
(12) Patent Application Publication
(10) Pub. No.: US 2009/0208822 A1
(43) Pub. Date: Aug. 20, 2009

(54) POWER SUPPLY UNIT INCLUDING SECONDARY BATTERY

(75) Inventors: Ryuichi MORIKAWA, Higashimurayama-shi (JP); Mami MIZUTANI, Hachioji-shi (JP); Fumitaka MOURI, Tokorozawa-shi (JP); Takafumi DOMOTO, Fuchu-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 12/370,970

(22) Filed: Feb. 13, 2009

(30) Foreign Application Priority Data
Feb. 14, 2008 (JP) 2008-033724

(51) Int. Cl. H01M 10/02

(52) U.S. Cl. 429/61

(57) ABSTRACT

A power supply unit includes: a plurality of secondary batteries connected in series; limiting resistors connected to individual electrodes of the plurality of secondary batteries; a voltage detection circuit detecting inter-terminal voltages of each of the plurality of secondary batteries based on potentials obtained from the plurality of secondary batteries through the limiting resistors; a control circuit specifying one of the secondary batteries to be discharged based on the inter-terminal voltages of the plurality of secondary batteries detected by the voltage detection circuit and sending a discharge instruction; and a discharge circuit allowing the specified secondary battery to discharge through the limiting resistors in response to the instruction from the control circuit.

### BACKGROUND OF THE INVENTION

1. Field of Invention

The present invention relates to a power supply unit including a secondary battery and specifically, relates to a technique to enhance safety of a power supply unit including a secondary battery when the power supply unit is at fault.

2. Description of the Related Art

In a secondary battery, a remaining charge estimation for estimating the charge of the secondary battery and charge/discharge control for preventing excessive charge and discharge are performed using measured battery voltage of the secondary battery. Moreover, in a power supply unit including a plurality of secondary batteries connected in series, when amounts of charges stored in the secondary batteries become imbalanced, some of the secondary batteries reach cutoff voltage earlier than the others at the time of charging/discharging. The total charge/discharge capacity of the power supply unit is therefore reduced. Accordingly, to equalize the battery voltages of the secondary batteries, balance control is carried out, which discharges the secondary batteries with higher voltage to equalize the amounts of charges of the secondary batteries.

As such a power supply unit including secondary batteries, Patent Literature 1 discloses a power supply unit in which secondary batteries are configured to be used for as long time as possible by detecting a deterioration causing a small short circuit repeatedly before positive and negative electrodes are completely short circuited. FIG. 1 is a circuit diagram showing voltage detection circuits 9 and discharge circuits 10 used in this conventional power supply unit.

The voltage detection circuits 9 of the conventional power supply unit individually detect voltages between positive and negative terminals of the respective secondary batteries C. Specifically, each of the voltage detection circuits 9 detects voltage of the positive terminal of the corresponding secondary battery C through a detection resistor 40 and a buffer circuit 41. Herein, the voltage of the negative terminal of the secondary battery C positioned at the most negative side among the plurality of secondary batteries C connected in series is the earth potential. Each operational amplifier 42 outputs, to a not-shown controller, a potential difference between voltage of the positive terminal of the corresponding secondary battery C and voltage of the positive terminal of the secondary battery C adjacent to the same on the positive terminal side.

The discharge circuit 10 is composed of a discharge path 45 connected between the positive and negative terminals of each secondary battery C in parallel thereto. The discharge path 45 is composed of a switching transistor 43 and discharge resistors 44. The switching transistor 43 is connected to the discharge resistors 44 in series. The switching transistor 43 is turned on/off through a photocoupler 47 by a control signal sent from the not-shown controller. Such a discharge path 45 is provided for each secondary battery C. The not-shown controller selectively gives the control signal to any of the discharge paths 45, thus selectively turn the discharge path 45 on or off.
Patent Publication 1: Japanese Patent Application Laid-open Publication No. 2003-9405.

However, in the aforementioned conventional power supply unit, the electrically conducting paths directly lead from the positive and negative electrodes of each secondary battery to the corresponding voltage detection circuit 9 and discharge circuit 10. Accordingly, if insulation failure occurs in these electrically conducting paths, the positive and negative electrodes of the secondary battery C are short-circuited.

The secondary batteries C generally use electrolyte liquid. The electrolyte liquid sometimes leaks to short the electrically conducting paths, thus forming a short circuit. In the thus-formed short circuit, there is no element controlling current other than only internal resistance of the secondary battery C and resistance of the electrically conducting path of the short circuit. Accordingly, there is a possibility that large current may flow through the short circuit and cause burnout of the secondary battery C.

Moreover, in the discharge circuit 10, a single failure such as a short circuit of any discharge resistor 44 causes a short circuit of the secondary battery 10, and this can cause burnout of the discharge circuit 10. Especially in a battery having large capacity or fast charge performance, the secondary batteries have low internal resistance, and there is a problem of safety.

### SUMMARY OF THE INVENTION

An object of the present invention is to provide a power supply unit including secondary batteries having such excellent safety that accidents due to a short circuit can be prevented.

To solve the aforementioned problems, a power supply unit according to a first aspect of the present invention includes: a plurality of secondary batteries connected in series; limiting resistors connected to individual electrodes of the plurality of secondary batteries; a voltage detection circuit detecting inter-terminal voltage between terminals of each of the plurality of secondary batteries based on potentials obtained from the plurality of secondary batteries through the limiting resistors; a control circuit specifying one of the secondary batteries to be discharged based on the inter-terminal voltages of the plurality of secondary batteries detected by the voltage detection circuit and sending an instruction to allow the specified secondary battery to discharge; and a discharge circuit allowing the specified secondary battery to discharge through the limiting resistors in response to the instruction received from the control circuit.

Herein, preferably, the discharge circuit includes a discharge resistor and a discharge switch which are connected in series between the limiting resistors connected to individual electrodes of the plurality of secondary batteries. In this case, the discharge switch is turned on or off in response to the instruction from the control circuit. With such a configuration, even if a short circuit occurs in the electrically conducting paths or discharge circuit because of insulation failure, a defective component of the discharge circuit, or the like, the limiting resistors limit the short-circuit current. Accordingly, the power supply unit and secondary batteries can avoid accidents due to short-circuit current such as firing or smoking.

Moreover, the power supply unit according to the first aspect of the present invention may further include: a disconnection determination voltage holding circuit which, upon receiving the instruction from the control circuit, calculates a certain value times the detected voltage detected by the voltage detection circuit when the discharge switch of the discharge circuit is off and holds the calculated value as disconnection determination voltage; and a comparator which compares the inter-terminal voltage detected by the voltage detection circuit with the respective disconnection determination voltage held by the disconnection determination voltage holding circuit or a disconnection determination voltage previously set and determines that there is a disconnection in electrically conducting paths connected to the secondary battery corresponding to the inter-terminal voltage which is smaller than the compared disconnection determination voltage.

With such a configuration, when there is a disconnection of the electrically connecting paths between the secondary batteries and the voltage detection circuit or an open defect of components, the detected voltage of any one of the secondary batteries is reduced to lower than the disconnection determination voltage. Accordingly, it is possible to reliably detect a fault such as a disconnection of the electrically connecting paths or an open defect of components.

Furthermore, the power supply unit according to the first aspect of the present invention may further include: a detected voltage compensation circuit which, upon receiving the instruction from the control circuit, calculates backward each of the battery voltages of the plurality of secondary batteries as each of compensated detected voltages based on the detected voltages detected by the voltage detection circuit, resistance values of the limiting resistors, and resistance values of the discharge resistors. In this case, the control circuit executes at least one of estimation of remaining charge, charge/discharge control, and balance control of the secondary batteries based on the compensated detected voltages calculated by the detected voltage compensation circuit.

Still furthermore, the power supply unit according to the first aspect of the present invention may further include: a detected voltage compensation circuit which, upon receiving the instruction from the control circuit, calculates backward battery voltage of the secondary battery corresponding to the discharge switch of the discharge circuit turned on and battery voltage of the secondary battery which is adjacent to the secondary battery corresponding to the discharge switch turned on as each of compensated detected voltages based on detected voltages detected by the voltage detection circuit of the secondary battery corresponding to the discharge switch turned on and the adjacent secondary battery, resistance values of the limiting resistors, and resistance values of the discharge resistors. In this case, the control circuit executes at least one of estimation of remaining charges, charge/discharge control, and balance control of the secondary batteries based on the compensated detected voltages calculated by the detected voltage compensation circuit and detected voltages of the secondary batteries other than the secondary battery corresponding to the discharge switch turned on and the adjacent battery which are detected by the voltage detection circuit.

With such detection voltage compensation circuits, the battery voltages are accurately detected even when any one of the discharge switches of the discharge circuit is on. Accordingly, the control circuit does not perform a wrong remaining charge estimation, wrong charge/discharge control, or the like. The wrong charge/discharge control of the control circuit may cause excessive charge of the secondary batteries or the like. However, the provision of the detected voltage correction circuit can prevent the secondary batteries from deteriorating or generating abnormal heat because of excessive charge or the like.

Still furthermore, the control circuit may activate the discharge circuit during a period except a period necessary for the voltage detection circuit to detect the inter-terminal voltages of the secondary batteries.

With such an operation of the control circuit, the control circuit can accurately detect the battery voltages even when activating the discharge circuit for the balance control. This prevents the control circuit from performing a wrong remaining charge estimation or charge/discharge control.

As described above, according to the first aspect of the present invention, it is possible to provide a power supply unit having such excellent safety that accidents due to a short circuit can be prevented.

### BRIEF DESCRIPTION OF THE DRAWINGS

FIG. 1 is a circuit diagram showing voltage detection circuits and discharge circuits used in a conventional power supply unit.

FIG. 2 is a block diagram showing a constitution of a main portion of a power supply unit according to Embodiment 1 of the present invention.

FIG. 3 is a circuit diagram showing a discharge circuit used in the power supply unit according to Embodiment 1 of the present invention.

FIG. 4 is a block diagram schematically showing a constitution of a power supply unit according to Embodiment 2 of the present invention.

FIG. 5 is a block diagram schematically showing a constitution of a power supply unit according to Embodiment 3 of the present invention.

FIG. 6 is a block diagram schematically showing a constitution of a power supply unit according to Embodiment 4 of the present invention.

FIG. 7 is a timing chart for explaining an operation of the power supply unit according to Embodiment 5 of the present invention.

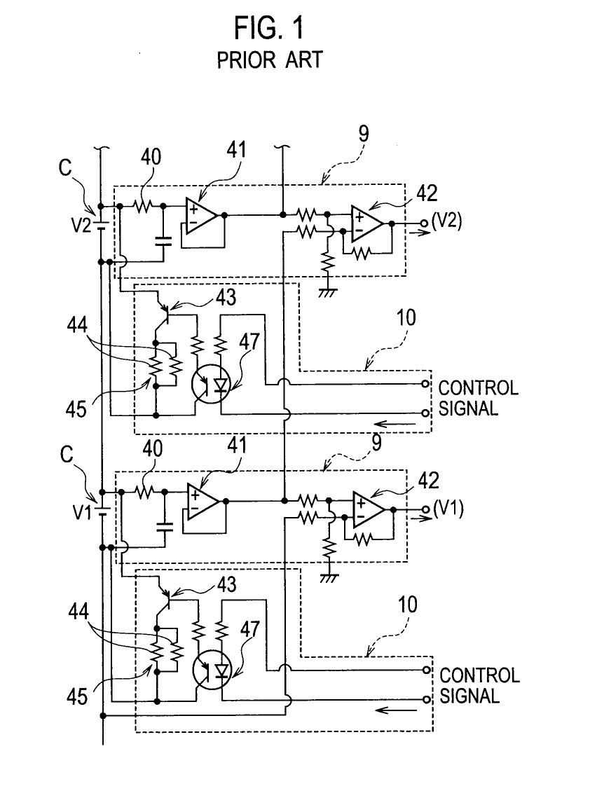

### DETAILED DESCRIPTION OF THE EMBODIMENTS

Hereinafter, a description is given of embodiments of the present invention with reference to the drawings. In the following description, constituent elements same or similar to those of the conventional power unit explained in Description of the Related Art are given same reference numerals as those used in Description of the Related Art.

### Embodiment 1

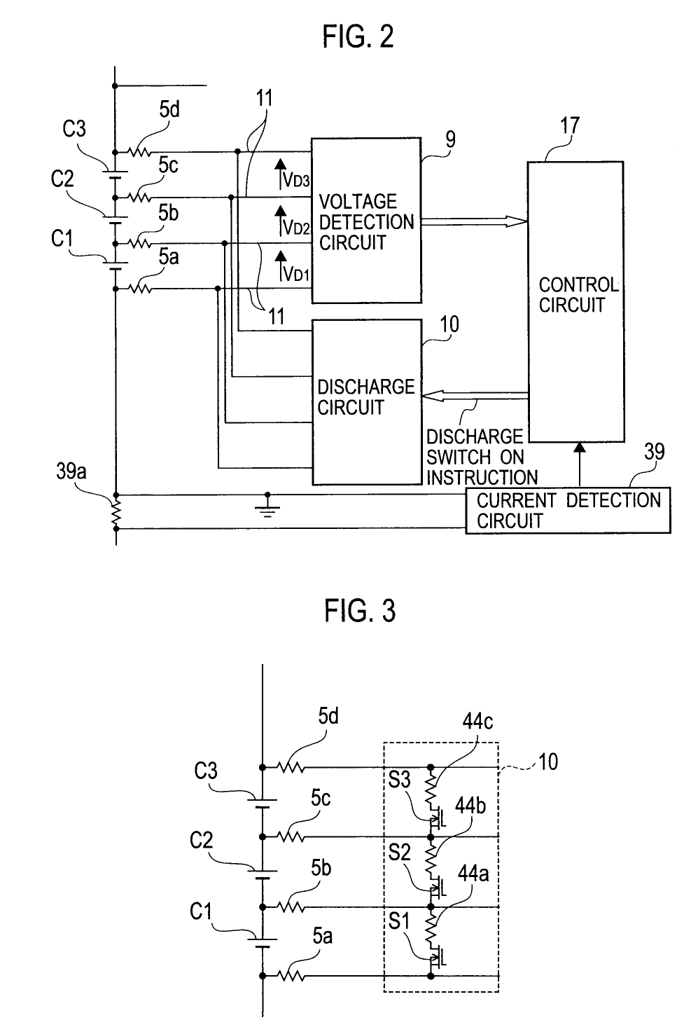

FIG. 2 is a block diagram showing a constitution of a main portion of a power supply unit according to Embodiment 1 of the present invention. The power supply unit includes a plurality of secondary batteries C1 to C3, limiting resistors 5a to 5d, a voltage detection circuit 9, a discharge circuit 10, a control circuit 17, a current detection resistor 39a, and a current detection circuit 39. FIG. 2 shows an example of the power supply unit provided with the three secondary batteries C1 to C3, but the number of secondary batteries can be arbitrarily determined.

The secondary batteries C1 to C3 are connected in series. One end of the limiting resistor 5a is connected to a negative electrode of the secondary battery C1, and the other end thereof is connected to the voltage detection circuit 9 and the discharge circuit 10 through electrically conducting paths 11. The limiting resistor 5a limits current flowing between the negative electrode of the secondary battery C1 and the voltage detection circuit 9 or the discharge circuit 10.

One end of the limiting resistor 5b is commonly connected to a positive electrode of the secondary battery C1 and a negative electrode of the secondary battery C2, and the other end thereof is connected to the voltage detection circuit 9 and the discharge circuit 10 through electrically conducting paths 11. The limiting resistor 5b limits current flowing between the connection point of the positive electrode of the secondary battery C1 and the negative electrode of the secondary battery C2 and the voltage detection circuit 9 or discharge circuit 10.

One end of the limiting resistor 5c is commonly connected to a positive electrode of the secondary battery C2 and a negative electrode of the secondary battery C3, and the other end thereof is connected to the voltage detection circuit 9 and discharge circuit 10 through electrically conducting paths 11. The limiting resistor 5c limits current flowing between the connection point of the positive electrode of the secondary battery C2 and the negative electrode of the secondary battery C3 and the voltage detection circuit 9 or discharge circuit 10.

One end of the limiting resistor 5d is connected to a positive electrode of the secondary battery C3, and the other end thereof is connected to the voltage detection circuit 9 and discharge circuit 10 through electrically conducting paths 11. The limiting resistor 5d limits current flowing between the positive electrode of the secondary battery C3 and the voltage detection circuit 9 or discharge circuit 10.

The voltage detection circuit 9 detects a magnitude of voltage between the terminals of the secondary battery C1 based on potentials obtained through the limiting resistors 5a and 5b and sends the detected magnitude to the control circuit 17 as a detected voltage V_{D1}. Moreover, the voltage detection circuit 9 detects a magnitude of voltage between the terminals of the secondary battery C2 based on potentials obtained through the limiting resistors 5b and 5c and sends the detected magnitude to the control circuit 17 as a detected voltage V_{D2}. Still moreover, the voltage detection circuit 9 further detects a magnitude of voltage between the terminals of the secondary battery C3 based on potentials obtained through the limiting resistors 5c and 5d and sends the detected magnitude to the control circuit 17 as a detected voltage V_{D3}.

The current detection resistor 39a is connected to the secondary batteries C1 to C3 in series. When current flows through the secondary batteries C1 to C3, the current detection resistor 39a produces a voltage proportional to the current between the both ends thereof. Moreover, the current detection circuit 39 is connected to the both ends of the current detection resistor 39a. The voltage produced at the current detection resistor 39a is measured by the current detection circuit 39. The connection point of the negative electrode of the secondary battery C1 and current detection resistor 39a is connected to the ground potential.

The current detection circuit 39 detects a magnitude of the current flowing through the secondary batteries C1 to C3 based on the voltage between the both ends of the current detection resistor 39a and sends the same to the control circuit 17 as a detected current.

The control circuit 17 executes at least one of a remaining charge estimation, charge/discharge control, and balance control of the secondary batteries C1 to C3 using the detected voltages V_{D1} to V_{D3} of the secondary batteries C1 to C3 sent from the voltage detection circuit 9, the detected current sent from the current detection circuit 39, temperature of the secondary batteries C1 to C3 detected by a not-shown temperature sensor, and the like. For example, the control circuit 17 sends a discharge switch ON instruction to the discharge circuit 10 to control discharge of the secondary batteries C1 to C3. Moreover, the control circuit 17 sends detected or estimated information to the outside of the power supply unit.

The discharge circuit 10 controls discharge of the secondary batteries C1 to C3 in response to the discharge switch ON instruction from the control circuit 17. As shown in FIG. 3, the discharge circuit 10 includes discharge resistors 44a to 44c and discharge switches S1 to S3. Each of the discharge switches S1 to S3 is composed of a semiconductor switch such as for example, an FET or a transistor and is turned on or off in response to the discharge switch ON instruction from the control circuit 17.

A discharge part composed of the discharge resistor 44a and discharge switch S1 controls discharge of the secondary battery C1. Specifically, upon receiving the discharge switch ON instruction from the control circuit 17, the discharge switch S1 is turned on. Current then flows through a path: the positive electrode of the secondary battery C1→the limiting resistor 5b→the discharge resistor 44a→the discharge switch S→the limiting resistor 5a→the negative electrode of the secondary battery C1. The secondary battery C1 is thus discharged.

In a similar manner, a discharge part composed of the discharge resistor 44b and discharge switch S2 controls discharge of the secondary battery C2. Specifically, upon receiving the discharge switch ON instruction from the control circuit 17, the discharge switch S2 is turned on. Current then flows through a path: the positive electrode of the secondary battery C2→the limiting resistor 5c→the discharge resistor 44b→the discharge switch S2→the limiting resistor 5b→the negative electrode of the secondary battery C2. The secondary battery C2 is thus discharged.

In a similar manner, a discharge part composed of the discharge resistor 44c and discharge switch S3 controls discharge of the secondary battery C3. Specifically, upon receiving the discharge switch ON instruction from the control circuit 17, the discharge switch S3 is turned on. Current then flows through a path: the positive electrode of the secondary battery C3→the limiting resistor 5d→the discharge resistor 44c→the discharge switch S3→the limiting resistor 5c→the negative electrode of the secondary battery C3. The secondary battery C3 is thus discharged.

Furthermore, the control circuit 17 sends the discharge switch ON instruction to the discharge switch corresponding to the secondary battery outputting a voltage higher than the other secondary batteries. The secondary battery corresponding to the discharge switch which receives the discharge switch ON instruction therefore discharges to balance the voltages of the plurality of secondary batteries C1 to C3.

In the power supply unit configured as described above, when there is a short circuit in the electrically conducting paths 11 or discharge circuit 10 because of insulation failure or the like, current flows through the limiting resistors 5a to 5d. Accordingly, the current flowing through the secondary batteries C1 to C3 is limited.

As described above, in the power supply unit according to Embodiment 1 of the present invention, even if there is a short circuit in the conducting paths 11 or discharge circuit 10 because of insulation failure, a defect of the discharge resistors 44a to 44c, and the like, the short-circuit current is limited by the limiting resistors 5a to 5d. The power supply unit and secondary batteries can avoid accidents caused by the short-circuit current such as firing or smoking.

### Embodiment 2

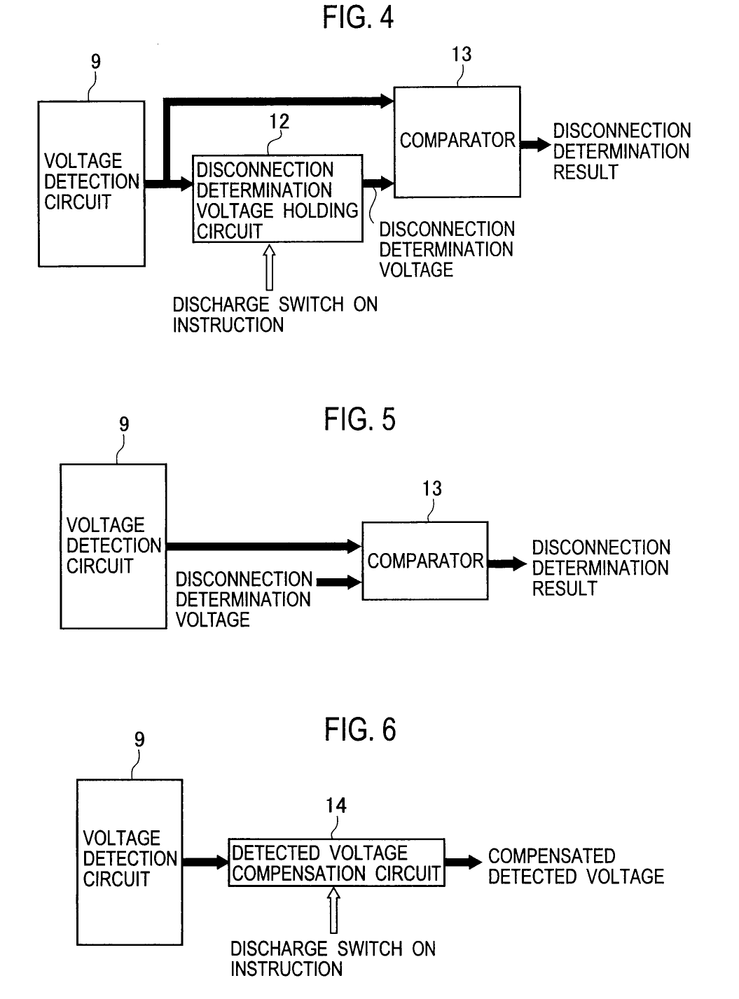

A power supply unit of Embodiment 2 shown in FIG. 4 further includes a disconnection determination voltage holding circuit 12 and a comparator 13 in addition to the power supply unit of Embodiment 1.

Upon receiving the discharge switch ON instruction from the control circuit 17, the disconnection determination voltage holding circuit 12 holds, as disconnection determination voltages, voltages equal to k times (k<1) the detected voltages detected by the voltage detection circuit 9 while the discharge switches S1 to S3 are off. The disconnection determination voltages held in the disconnection determination voltage holding circuit 12 are sent to the comparator 13.

The comparator 13 compares the disconnection determination voltages held by the disconnection determination voltage holding circuit 12 and the respective detected voltages V_{D1}, V_{D2}, and V_{D3} detected by the voltage detection circuit 9. When the detected voltage V_{D1}, V_{D2}, or V_{D3} is smaller than the respective disconnection determination voltages, the comparator 13 determines that there is a disconnection in the electrically conducting paths 11 connected to the secondary battery C1, C2, or C3 corresponding to the detected voltage V_{D1}, V_{D2}, or V_{D3} which is smaller than the corresponding disconnection determination voltage. The result of the determination by the comparator 13 is sent to the outside.

In the power supply unit according to Embodiment 2 configured as described above, the control circuit 17 turns on/off the discharge switches S1 to S3 of the discharge circuit 10 at proper time intervals. In this case, if the discharge switches S1 to S3 are turned on while the battery charges of the secondary batteries C1 to C3 are balanced, the charges of the secondary batteries C1 to C3 are unnecessarily discharged. Accordingly, the time in which the discharge switches S1 to S3 are on is made short enough not to greatly affect the charges stored in the secondary batteries C1 to C3.

When it is determined by the comparator 13 in such a state that there is a disconnection, the secondary batteries C1 to C3 cannot be safely used. Accordingly, the comparator 13 notifies a user of the failure of the power supply unit or informs an upper system of the failure of the power supply unit, thus securing the safety of the power supply unit.

Herein, consideration is given to the case where the discharge switch S2 of the discharge circuit 10 corresponding to the secondary battery C2 is turned on. In this case, the detected voltage V_{D2} detected by the voltage detection circuit 9 is expressed by the following equation,

$${V}_{D 2} = \frac{{R}_{2}}{2 {R}_{1} + {R}_{2}} {V}_{C 2} , \qquad ( 1 )$$

herein, R₁ indicates the resistance value of the limiting resistors 5b and 5c; R₂, the resistance value of the discharge resistor 44b; and V_{C2}, the battery voltage of the secondary battery C2. If the conduction resistances of the discharge switches S1 to S3 are included in R₂, the detected voltage V_{D2} can be calculated more accurately.

Equation (1) above calculates the detected voltage V_{D2} detected when the discharge switch S2 is turned on, and the detected voltages V_{D1} and V_{D2} detected when the other discharge switch S1 or S3 is turned on can be obtained in a similar manner. Moreover, k is set to a value smaller than R₂/(2R₁+R₂) based on equation (1).

Moreover, when the discharge switch S2 is turned on, the detected voltages V_{D1} and V_{D3} of the discharge switches S1 and S3 adjacent thereto on both sides are expressed by the following equations,

$$\begin{matrix}{V}_{D 1} = {V}_{C 1} + \frac{{R}_{1}}{2 {R}_{1} + {R}_{2}} {V}_{C 2} , & ( 2 ) \\ {V}_{D 3} = {V}_{C 3} + \frac{{R}_{1}}{2 {R}_{1} + {R}_{2}} {V}_{C 2} , & ( 3 )\end{matrix}$$

herein, V_{C1} and V_{C3} indicate the battery voltages of the secondary batteries C1 and C3, respectively.

As shown in equations (1) to (3), when any one of the discharge switches S1 to S3 is turned on, the detected voltages detected by the voltage detection circuit 9 have values different from the battery voltages of the respective secondary batteries C1 to C3. Accordingly, the disconnection determination voltage holding circuit 12 generates the disconnection determination voltage using the detected voltages detected during a period when the discharge switches S1 to S3 are off.

As described above, the power supply unit of Embodiment 2 of the present invention has the following effect. Specifically, in the power supply unit of Embodiment 1 shown in FIG. 2, when there is a disconnection of the electrically conducting paths 11 between the secondary batteries C1 to C3 and the voltage detection circuit 9 or an open defect of components, the voltages of the secondary batteries C1 to C3 are divided by the input impedances of the voltage detection circuit 9.

The detected voltages V_{D1} to V_{D3} detected in this case are sometimes different from the battery voltages V_{C1} to V_{C3} of the secondary batteries C1 to C3. If the battery voltages V_{C1} to V_{C3} of the secondary batteries C1 to C3 cannot be accurately detected, there is a possibility that fault of the battery voltages V_{C1} to V_{C3} is not noticed. Under ordinary circumstances, it is necessary to detect the abnormal voltage and limit the charge/discharge current supplied to the secondary batteries C1 to C3. However, without such a measure, the secondary batteries C1 to C3 will deteriorate or generate abnormal heat, and at worse, will fire or smoke.

On the other hand, in the power supply unit of Embodiment 2 of the present invention, when there is a disconnection of the electrically conducting paths 11 between the secondary batteries C1 to C3 and the voltage detection circuit 9 or an open defect of components, the detected voltages V_{D1} to V_{D3} of the secondary batteries C1 to C3 are reduced to lower than the disconnection determination voltage. It is therefore possible to reliably detect a failure such as a disconnection of the electrically conducting paths or an open defect of components.

### Embodiment 3

In a power supply unit of Embodiment 3 of the present invention shown in FIG. 5, a fixed value smaller than the result of multiplying a minimum value of the voltage of the secondary batteries C1 to C3 varying in a normal range of use by R₂/(2R₁+R₂) is used as a disconnection determination voltage instead of the disconnection determination voltages held by the disconnection determination voltage holding circuit 12 of the power supply unit of Embodiment 2.

An operation of the power supply unit according to Embodiment 3 is the same as that of the power supply unit according to Embodiment 2 above except that the disconnection determination voltage takes a fixed value. The power supply unit according to Embodiment 3 can provide a similar effect to that of the power supply unit according to Embodiment 2.

### Embodiment 4

FIG. 6 is a block diagram schematically showing a configuration of the power supply unit according to Embodiment 4 of the present invention. This power supply unit further includes a detected voltage compensation circuit 14 in addition to the power supply unit according to Embodiment 1.

The detected voltage compensation circuit 14 receives the discharge switch ON instruction sent from the control circuit 17 and calculates battery voltages of the secondary batteries based on the detected voltages detected by the voltage detection circuit 9 using a method described below. The detected voltage compensation circuit 14 sends the calculated voltages to the control circuit 17 as compensated detected voltages. The control circuit 17 executes a remaining charge estimation, charge/discharge control, or balance control by using the compensated detected voltages sent from the detected voltage compensation circuit 14 instead of the detected voltages sent from the voltage detection circuit 9.

Next, a description is given of the method of calculating the compensated detected voltages. When the discharge switch S2 of the discharge circuit 10 is turned on by the control circuit 17, the detected voltages V_{D1} to V_{D3} shown in above equations (1) to (3) are detected by the voltage detection circuit 9. The detected voltages V_{D2} to V_{D3} are different from the respective battery voltages V_{C1} to V_{C3} of the secondary batteries C1 to C3. Accordingly, if the control circuit 17 estimates the remaining charges or performs charge/discharge control to prevent excessive charge or discharge by directly using the detected voltages V_{C1} to V_{C3}, wrong estimation of remaining charges or wrong charge/discharge control is performed.

When the discharge switch S2 is turned on, the battery voltages V_{C1} to V_{C3} of the secondary batteries C1 to C3 are calculated by the following equations based on the detected voltages V_{D1} to V_{D3} detected by the voltage detection circuit 9. The following equations are calculated backward from equations (1) to (3),

$$\begin{matrix}{V}_{C 1} = {V}_{D 1} - \frac{{R}_{1}}{{R}_{2}} {V}_{D 2} , & ( 4 ) \\ {V}_{C 2} = \frac{2 {R}_{1} + {R}_{2}}{{R}_{2}} {V}_{D 2} , & ( 5 ) \\ {V}_{C 3} = {V}_{D 3} - \frac{{R}_{1}}{{R}_{2}} {V}_{D 2} . & ( 6 )\end{matrix}$$

When the discharge switch S1 is turned on, the battery voltages V_{C1} to V_{C3} of the secondary batteries C1 to C3 are calculated by the following equations in a similar manner based on the detected voltages V_{D1} to V_{D3} detected by the voltage detection circuit 9,

$$\begin{matrix}{V}_{C 1} = \frac{2 {R}_{1} + {R}_{2}}{{R}_{2}} {V}_{D 1} , & ( 7 ) \\ {V}_{C 2} = {V}_{D 2} - \frac{{R}_{1}}{{R}_{2}} {V}_{D 1} , & ( 8 ) \\ {V}_{C 3} = {V}_{D 3} . & ( 9 )\end{matrix}$$

Also when the discharge switch S3 is turned on, the battery voltages V_{C1} to V_{C3} of the secondary batteries C1 to C3 can be calculated in a similar manner based on the detected voltages V_{D1} to V_{D3} detected by the voltage detection circuit 9.

As shown in equations (5) and (7), when one of the discharge switches is turned on, the battery voltage of the secondary battery corresponding to the discharge switch turned on is calculated by multiplying the detected voltage of the secondary battery by (2R₁+R₂)/R₂.

Moreover, as shown in equations (4), (6), and (8), when one of the discharge switches is turned on, battery voltage of each of the secondary batteries adjacent to the secondary battery corresponding to the discharge switch turned on can be calculated by subtracting R₁/R₂ times the detected voltage of the secondary battery corresponding to the discharge switch turned on from the detected voltage of the same adjacent secondary battery.

Furthermore, as shown in equation (9), the battery voltage of the secondary battery which corresponds to any one of the discharge switches turned off and is not adjacent to the secondary battery corresponding to the discharge switch turned on is equal to the detected voltage of the same.

As described above, according to the power supply unit of Embodiment 4 of the present invention, in addition to the effect of the power supply unit of Embodiment 1, the battery voltages can be accurately detected even when any one of the discharge switches is on. Accordingly, the power supply unit of Embodiment 4 does not perform wrong estimation of remaining charges or wrong charge/discharge control. The wrong charge/discharge control may cause excessive charge or the like, but with the power supply unit according to Embodiment 4, it is possible to prevent the secondary batteries from deteriorating or generating abnormal heat.

### Embodiment 5

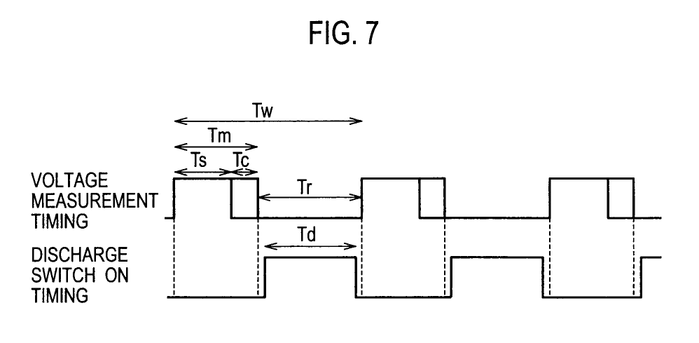

The configuration of the power supply unit of Embodiment 5 of the present invention is the same as that of the power supply unit according to Embodiment 1, and only operations thereof are different from each other. Hereinafter, a description is given of mainly the points different from Embodiment 1 with reference to the timing chart shown in FIG. 7.

When the voltage detection circuit 9 detects the voltages of the secondary batteries at time intervals of voltage measurement period Tw, the measurement requires voltage measurement period Tm equal to the sum of stabilization period Ts taken for the detected voltages V_{D1} to V_{D2} to be stabilized and transform period Tc to obtain the voltages.

In the power supply unit of Embodiment 5, when the voltages of the secondary batteries become imbalanced, the discharge switches S1 to S3 are turned on during measurement idle period Tr, which is equal to a result of subtracting the voltage measurement Tm from the voltage measurement period Tw. In other words, ON period Td of the discharge switches S1 to S3 is included within the measurement idle period Tr and is set equal to or shorter than the measurement idle period Tr. The battery voltages of the secondary batteries can be therefore accurately detected while the operation of balancing the voltages of the secondary batteries is performed.

As described above, according to the power supply unit of Embodiment 5 of the present invention, in addition to the effect of the power supply unit of Embodiment 1, the battery voltages can be accurately detected even while the discharge switches are activated for balance control. Accordingly, the power supply unit of Embodiment 5 does not perform wrong estimation of remaining charges or wrong charge/discharge control. The wrong charge/discharge control may cause excessive charge or the like. However, the power supply unit of Embodiment 5 can prevent the secondary batteries from deteriorating or generating abnormal heat.

What is claimed is:

1. A power supply unit comprising:
a plurality of secondary batteries connected in series;
limiting resistors connected to individual electrodes of the plurality of secondary batteries;
a voltage detection circuit detecting inter-terminal voltage between terminals of each of the plurality of secondary batteries based on potentials obtained from the plurality of secondary batteries through the limiting resistors;
a control circuit specifying one of the secondary batteries to be discharged based on the inter-terminal voltages of the plurality of secondary batteries detected by the voltage detection circuit and sending an instruction to allow the specified secondary battery to discharge; and
a discharge circuit allowing the specified secondary battery to discharge through the limiting resistors in response to the instruction received from the control circuit.

2. The power supply unit according to claim 1, wherein
the discharge circuit includes a discharge resistor and a discharge switch which are connected in series between the limiting resistors connected to individual electrodes of the plurality of secondary batteries, and
the discharge switch is turned on or off in response to the instruction from the control circuit.

3. The power supply unit according to claim 2, further comprising:
a disconnection determination voltage holding circuit which, upon receiving the instruction from the control circuit, calculates a certain value times the detected voltage detected by the voltage detection circuit when the discharge switch of the discharge circuit is off and holds the calculated value as the disconnection determination voltage, and
a comparator which compares the inter-terminal voltages detected by the voltage detection circuit with the respective disconnection determination voltage held by the disconnection determination voltage holding circuit or a disconnection determination voltage previously set and determines that there is a disconnection of electrically conducting paths connected to the secondary battery corresponding to the inter-terminal voltage which is smaller than the compared disconnection determination voltage.

4. The power supply unit according to claim 2, further comprising:
a detected voltage compensation circuit which, upon receiving the instruction from the control circuit, calculates backward each of the battery voltages of the plurality of secondary batteries as each of compensated detected voltages based on the detected voltages detected by the voltage detection circuit, resistance values of the limiting resistors, and resistance values of the discharge resistors, wherein
the control circuit executes at least one of estimation of remaining charge, charge/discharge control, and balance control of the secondary batteries based on the compensated detected voltages calculated by the detected voltage compensation circuit.

5. The power supply unit according to claim 2, further comprising:
a detected voltage compensation circuit which, upon receiving the instruction from the control circuit, calculates backward battery voltage of the secondary battery corresponding to the discharge switch of the discharge circuit turned on and battery voltage of the secondary battery adjacent to the secondary battery corresponding to the discharge switch turned on as each of compensated detected voltages based on detected voltages detected by the voltage detection circuit of the secondary battery corresponding to the discharge switch turned on and the adjacent secondary battery, resistance values of the limiting resistors, and resistance values of the discharge resistors, wherein
the control circuit executes at least one of estimation of remaining charge, charge/discharge control, and balance control of the secondary batteries based on the compensated detected voltages calculated by the detected voltage compensation circuit and detected voltages of the secondary batteries other than the secondary battery corresponding to the discharge switch turned on and the adjacent battery which are detected by the voltage detection circuit.

6. The power supply unit according to claim 2, wherein
the control circuit activates the discharge circuit during a period except a period necessary for the voltage detection circuit to detect the inter-terminal voltages of the secondary batteries.
